(19) United States
(12) Patent Application Publication
(10) Pub. No.: US 2016/0186729 A1
(43) Pub. Date: Jun. 30, 2016

(54) System For Generating Electric Power In Situ For An Underwater Or Overhead Cable

(71) Applicant: COMMISSARIAT A L'ENERGIE ATOMIQUE ET AUX ENERGIES ALTERNATIVES, Paris (FR)

(72) Inventor: Luc Aixala, Saint Egreve (FR)

(21) Appl. No.: 14/976,649

(22) Filed: Dec. 21, 2015

(30) Foreign Application Priority Data
Dec. 22, 2014 (FR) 1463079

(51) Int. Cl. F03D 11/02; F03D 9/00; F03B 13/10

(52) U.S. Cl. CPC F03D 11/04; F03D 9/002; F03B 13/10

(57) ABSTRACT

A renewable power recovery system for locally generating electric power, particularly associated with an overhead or underwater cable or with an overhead or underwater pipe. This system includes a turbine having a substantially cylindrical external casing rotatably mounted on the cable or on the pipe by way of mounting members and an alternator cinematically connected or integrated to the turbine. The mounting members and the turbine are made of two severable portions, provided with assembly elements to allow their assembly once they have been positioned on the cable or on the pipe.

### FIELD OF THE INVENTION

The present invention relates to the general technical field of pipes and cables enabling to convey either fluids, or electric power and/or data. Such cables or pipes may be submerged in a marine environment or arranged in overhead fashion.

The present invention more particularly relates to the recovery of renewable submarine or overhead power, of low power, to supply with electric power mainly control and monitoring sensors associated with such a cable or with such a pipe. It is indeed necessary to equip this type of cable or of pipe with sensors of stress, pressure, temperature, or for example capable of detecting other physical parameters such as vibrations, to be able to identify or anticipate a possible premature aging, risks of breaking, or abnormal embedment, requiring a maintenance operation.

Such control sensors enable to monitor the state and the environment of a cable or of a pipe, particularly submerged, having a very limited accessibility. Such sensors need to be electrically powered to be able to operate and to transmit measurements with electric signals. The latter then enable to perform a remote control and to avoid using cells or batteries, which have a relatively short autonomy and accordingly require being frequently replaced.

### BACKGROUND OF THE INVENTION

The use of power recovery systems, particularly of marine current type, powering such control sensors, is known. Thus, document US 2013/0147199 describes a power recovery system comprising a turbine associated with an alternator to generate the electricity necessary for the operation of the control sensors. Such turbines, known per se, are mounted on pipes or rigid cables. Known systems thus enable to generate in situ the electric power necessary for their operation.

Such systems however prove to be poorly adapted to being mounted on flexible cables or pipes. Such flexible pipes are for example used in an underwater environment to convey fluids, and this, over very long distances. The pipes or cables further have to be taken out of the water to be equipped with electric power generation systems or to replace such defective systems, and are generally stored on spools.

It should further be noted that the use of known systems implies using, in particular, underwater turbines or wind turbines, which are not capable of being mounted on flexible pipes or cables. Indeed, repeated flexions of the concerned cable or pipe result in generating substantial efforts and mechanical stress, likely to thus favor premature failures.

### SUMMARY OF THE INVENTION

The present invention aims at overcoming the above-mentioned disadvantages and at providing a local power recovery system capable of being mounted on a flexible cable or pipe.

Another object of the present invention aims at providing a power recovery system capable of being mounted on a cable or on a pipe which is already installed or submerged, requiring neither a taking out of the water nor a dismounting.

The objects of the invention are achieved by means of a renewable power recovery system to locally generate electric power intended to power, in particular, control sensors, associated with an overhead or underwater cable or with an overhead or underwater pipe, said system comprising a turbine having a substantially cylindrical external casing rotatably mounted on the cable or on the pipe by means of mounting members and an alternator cinematically connected or integrated to said turbine.

According to the invention, the mounting members and the turbine are made of two severable portions, provided with assembly elements to allow their assembly once they have been positioned on the cable or on the pipe.

Advantageously, all the parts constitutive of the power recovery system according to the invention are made of two severable portions. The same applies for the alternator according to an embodiment of the system according to the invention.

According to an embodiment of the invention, each longitudinal end of the turbine is formed by the ends of blades interconnected via a circular ring supporting assembly elements.

According to an embodiment of the invention, the mounting members are designed to adapt on a flexible cable or pipe, said mounting members comprising for this purpose means for absorbing or avoiding efforts and stress resulting from a flexion of said cable or of said pipe.

According to an embodiment of the invention, the mounting members comprise a bearing extending along a central plane transversal to the turbine, said single bearing thus forming, due to its positioning, the compensation means.

According to an embodiment of the invention, the mounting members comprise a first bearing arranged at a first longitudinal end of the turbine, and a second bearing arranged at a second longitudinal end of said turbine, said second bearing being connected to the cable or to the pipe via the compensation means.

According to another embodiment of the system according to the invention, the compensation means comprise:

a support secured to the pipe or the cable,

said support being provided on its external periphery with radial tabs angularly spaced apart by 90°, and

a peripheral body surrounding the support and provided with internal radial guide rails, each engaged, with a mechanical clearance, on a radial tab, the second bearing being fixedly mounted with its internal portion on said peripheral body, its external portion being secured to the turbine.

According to an embodiment of the invention, the support comprises an internal ball joint portion fixedly mounted on the cable or on the pipe and an external ball joint portion comprising the radial tabs and movably mounted on the internal ball joint portion.

The objects of the present invention are also achieved:

for a flexible electric and/or communication cable, comprising at least one power recovery system such as described hereabove;

for a flexible pipe for conveying fluids, comprising at least one power recovery system such as described hereabove.

An advantage of the power recovery system according to the invention lies in that it is able to easily equip a flexible cable or pipe with a power recovery system, for example, as it is being unwound from a ship.

Another advantage of the system according to the invention lies in the possibility of equipping a cable or a pipe, for example, in an underwater environment without having to take said cable or said pipe back up to the surface. This results in a substantial time gain for such an operation.

The system according to the invention has the determining advantage of being able to equip flexible cables or pipes without risking altering the lifetime of said system, and this due to a decrease in the mechanical efforts that said power recovery system has to undergo.

### BRIEF DESCRIPTION OF THE DRAWINGS

The foregoing and other features and advantages will also appear from the following non-limiting description of the invention in connection with the accompanying drawings, among which:

FIG. 1 is a simplified illustration of an embodiment of a turbine of a power recovery system according to the invention;

FIG. 2 is a cross-section view of one end of the turbine of FIG. 1 mounted on a cable or a pipe;

FIGS. 3a and 3b respectively illustrate, in cross-section views, two examples of mounting of the other end of the turbine of FIG. 1,

FIG. 4 schematically illustrates another embodiment of the power recovery system according to the invention, and

FIG. 5 schematically shows, in a partial cross-section view, a detail of an embodiment of a power recovery system according to the invention.

### DETAILED DESCRIPTION OF THE INVENTION

The elements which are structurally and functionally identical, present on a plurality of drawings, keep the same numerical or alphanumeric references.

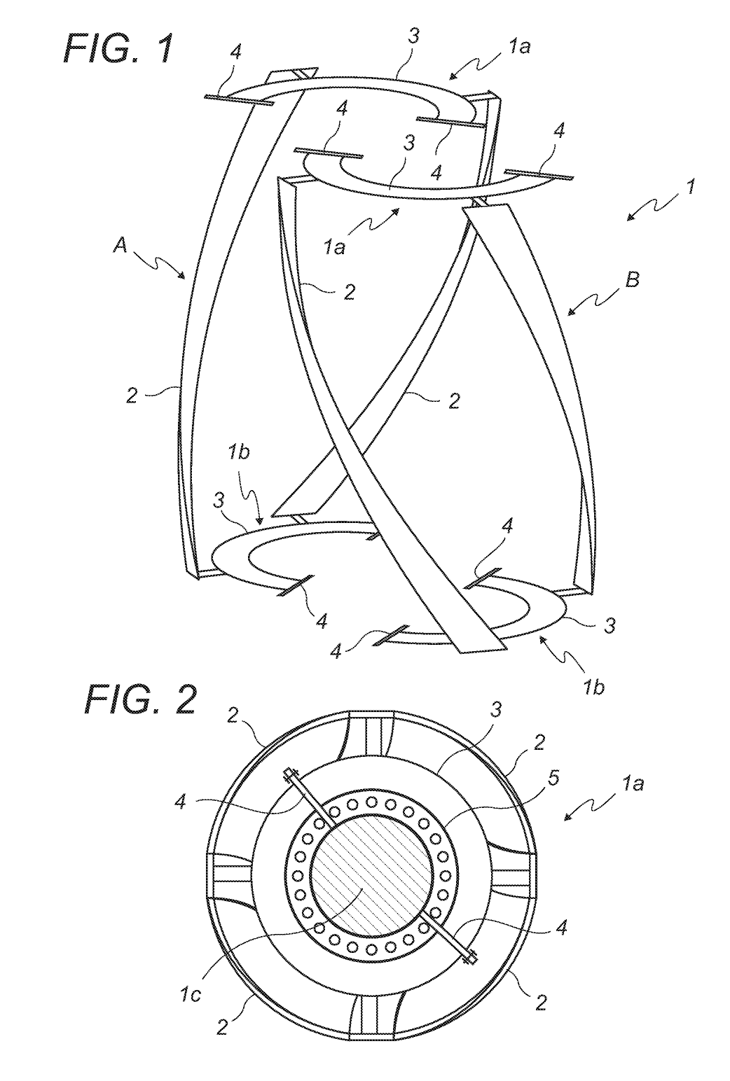

FIG. 1 schematically illustrates a turbine 1 of a power recovery system according to the invention. Turbine 1 has an external casing of substantially cylindrical shape with blades 2 interconnected at each of the longitudinal ends of said turbine 1, and this, via a connection ring 3.

Turbine 1 is advantageously associated with an alternator, which powers control and monitoring sensors, also not shown.

Mounting members, turbine 1, and the alternator are advantageously made of two severable portions, as can be observed in FIG. 1.

Thus, turbine 1 is made of two portions A and B, shown separately in FIG. 1. Once portions A and B have been positioned around a cable or a pipe 1c, they are assembled via assembly elements 4. A fast and easy mounting of turbine 1 on a cable or on a pipe 1c is thus obtained. This also makes separation or a dismounting easier.

Assembly elements 4 are known as such and are thus not described any further. As an example, connections of screw-nut, clamp, or other types can be mentioned.

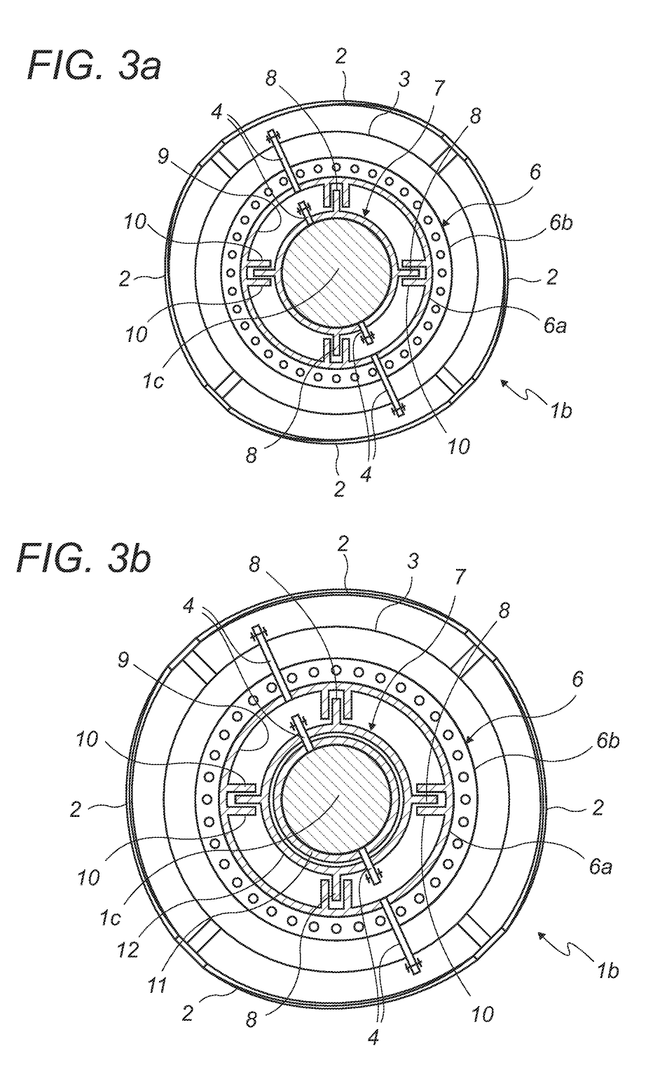

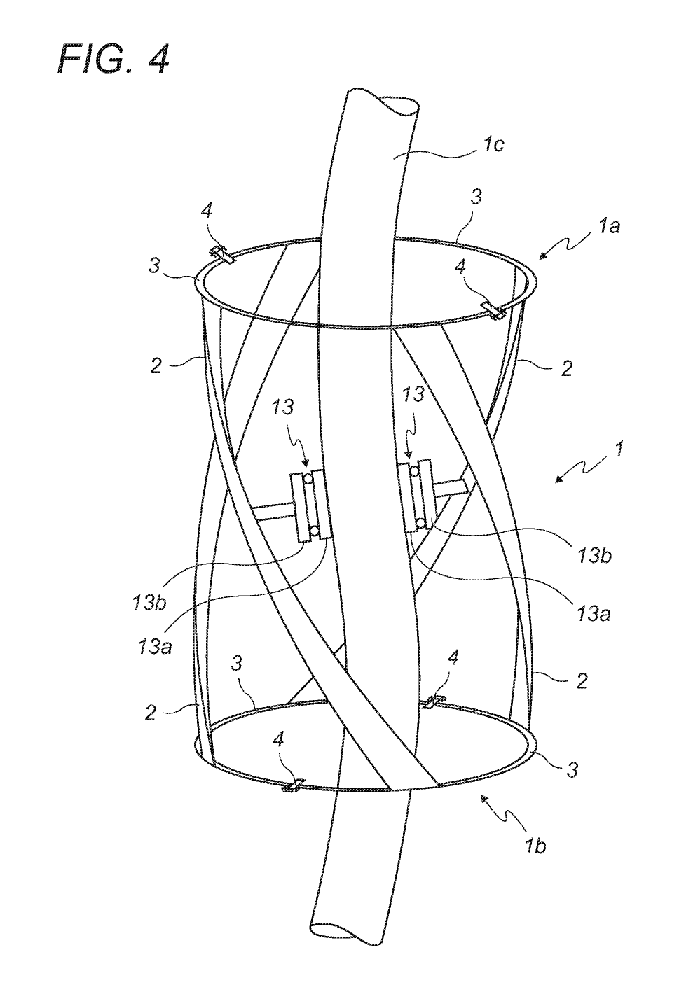

According to the embodiment of the power recovery system according to the invention illustrated in FIGS. 2 and 3a, turbine 1 has a first longitudinal end 1a or upper portion, where the mounting members comprise a first bearing 5 forming the interface between connection ring 3 and cable or pipe 1c. The two portions of first bearing 5 are advantageously clamped and maintained in position by ring 3. As a variation, first bearing 5 may also be provided with assembly elements 4.

Cable or pipe 1c is flexible. An underwater pipe 1c intended, for example, to convey a fluid, such as oil, may have a 80-cm diameter.

A second bearing 6 is arranged at a second longitudinal end 1b or lower portion of said turbine 1. Second bearing 6 is connected to cable or to pipe 1c via effort and stress compensation means.

The compensation means comprise a support 7 secured to pipe or cable 1c. Support 7 is provided on its external periphery with radial tabs 8 angularly spaced apart by 90°. Radial tabs 8 freely extend away from cable or from pipe 1c.

The compensation means also comprise a peripheral body 9 surrounding support 7, and provided with internal radial guide rails 10.

Guide rails 10 each cooperate, with a mechanical clearance, on a radial tab.

Second bearing 6 is fixedly mounted on peripheral body 9 with its inner portion 6a. External portion 6b of second bearing 6 is secured to turbine 1. This securing is obtained via ring 3 of second longitudinal end 1b, clamping said second bearing 6.

Support 7, peripheral part 9, and second bearing 6 are made of two portions interconnected by assembly elements 4.

According to another embodiment, assembly elements 4 are only provided on ring 3 and on support 7. The two portions, respectively of peripheral part 9 and of second bearing 6, abut each other and are held in position by ring 3.

Another embodiment of the power recovery system according to the invention is illustrated in FIGS. 2 and 3b. In this embodiment, at the level of second longitudinal end 1b, support 7 comprises a ball joint. Thus, an internal ball joint portion 11 is fixedly mounted to cable or pipe 1c, and an external ball joint portion 12 comprising radial tabs 8 is movably mounted on said internal ball joint portion 11.

Internal ball joint portion 11, external ball joint portion 12, peripheral portion 9, and second bearing 6 are made of two portions interconnected by assembly elements 4.

According to another embodiment, assembly elements 4 are only provided on ring 3 and on external ball joint portion 12, the two parts of internal ball joint portion 11 being held in position by said external ball joint portion 12. The two portions, respectively of peripheral part 9 and of second bearing 6, abut each other and are held in position by ring 3.

Thus, in addition to the two transverse degrees of liberty allowed by a sliding of guide rails 10 on radial tabs 8, it is possible to obtain, with the embodiment illustrated in FIG. 3b, a rotating motion around an additional rotation axis between the axis of cable or pipe 1c and the axis of turbine 1. The efforts generated by a flexion of cable or pipe 1c may thus be absorbed with a maximum efficiency. The mechanical stress on turbine 1 is thus substantially decreased.

FIG. 4 illustrates another embodiment of the power recovery system according to the invention, where the mounting members comprise a bearing 13 extending along a central plane transversal to turbine 1.

The connection obtained via this single bearing 13 enables to form the compensation means. Bearing 13, advantageously formed by a roller bearing, comprises an internal portion 13a fastened to cable or pipe 1c, and an external portion 13b secured to turbine 1. Bearing 13 advantageously is a roller bearing to withstand the cantilevers of turbine 1.

Each longitudinal end 1a and 1b is free and formed by the ends of blades 2 interconnected via a circular ring 3. The assembly elements provided on rings 3 and on internal 13a and external 13b bearing portion enable to assemble and to mount the power recovery system on cable or pipe 1c.

A configuration such as shown in FIG. 4 then enables to avoid for a flexion or a twisting of cable or pipe 1c to generate stress or efforts adversely affecting turbine 1.

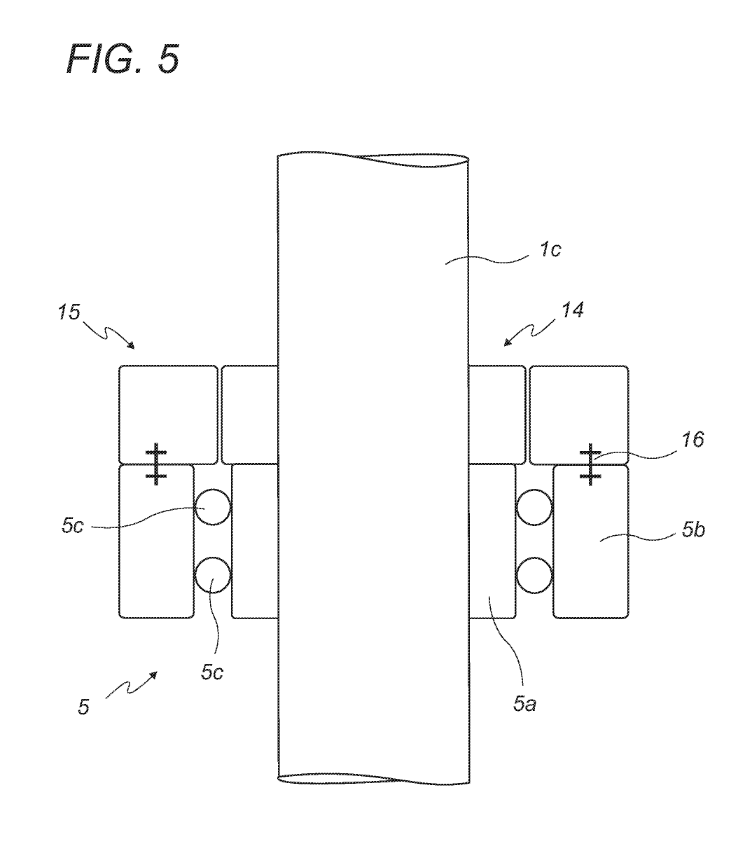

As an example, FIG. 5 schematically illustrates an example of mounting of an alternator in two portions on cable or pipe 1c. First bearing 5, of ball bearing type, comprises a fixed inner ring 5a and a mobile outer ring 5b. The alternator comprises, on the one hand, a stator 14 comprising windings and secured to inner ring 5a and, on the other hand, a rotor 15 mounted on outer ring 5b by means of fastening elements 16.

Of course, the present disclosure is not limited to the examples explicitly described, but also comprises other embodiments and/or implementation modes. Thus, a described technical characteristic may be replaced with an equivalent technical characteristic, without departing from the framework of the present invention.

1. A renewable power recovery system to locally generate electric power intended to power, in particular, control sensors, associated with an overhead or underwater cable or with an overhead or underwater pipe, said system comprising a turbine having a substantially cylindrical external casing rotatably mounted on the cable or on the pipe by means of mounting members and an alternator cinematically connected or integrated to said turbine, wherein the mounting members and the turbine are made of two severable portions, provided with assembly elements to allow their assembly once they have been positioned on the cable or on the pipe.

2. The renewable power recovery system of claim 1, wherein each longitudinal end of the turbine is formed by the ends of blades interconnected via a circular ring supporting assembly element.

3. The renewable power recovery system of claim 2, wherein the mounting members are designed to adapt on a cable or on a flexible pipe, said mounting members comprising for this purpose means for absorbing or avoiding efforts and stress resulting from a flexion or a twisting of said cable or of said pipe.

4. The renewable power recovery system of claim 3, wherein the mounting members comprise a bearing extending along a central plane transversal to the turbine, said single bearing thus forming, due to its positioning, the compensation means.

5. The renewable power recovery system of claim 3, wherein the mounting members comprise a first bearing arranged at a first longitudinal end of the turbine, and a second bearing arranged at a second longitudinal end of said turbine, said second bearing being connected to the cable or to the pipe via the compensation means.

6. The renewable power recovery system of claim 5, wherein the compensation means comprise:
a support secured to the pipe or to the cable,
said support being provided on its external periphery with radial tabs angularly spaced apart by 90°, and
a peripheral body surrounding the support and provided with internal radial guide rails, each engaged, with a mechanical clearance, on a radial tab, the second bearing being fixedly mounted with its internal portion on said peripheral body, the external portion of said second bearing being secured to the turbine.

7. The renewable power recovery system of claim 6, wherein the support comprises an internal ball joint portion fixedly mounted to the cable or to the pipe and an external ball joint portion comprising the radial tabs and movably mounted on the internal ball joint portion.

8. A flexible electric and/or communication cable comprising at least the system of claim 1.

9. A flexible pipe for conveying fluids comprising at least the system of claim 1.
